(19) United States
(12) Patent Application Publication
(10) Pub. No.: US 2017/0083771 A1
(43) Pub. Date: Mar. 23, 2017

(54) VEHICLE MOUNTED SIDE CAMERA SYSTEM

(71) Applicant: David Clark, Altavista, VA (US)

(72) Inventor: David Clark, Altavista, VA (US)

(21) Appl. No.: 14/857,152

(22) Filed: Sep. 17, 2015

(51) Int. Cl. G06K 9/00; H04W 4/00; H04N 5/14; H04N 7/18; H04N 5/225; H04N 5/232

(52) U.S. Cl. CPC G06K 9/00771; H04N 5/2253; H04N 5/23293; H04N 5/2256; H04N 5/144; H04N 7/181; H04W 4/008

(57) ABSTRACT

A vehicle mounted side camera system for providing real time side view video of the area in front or behind a vehicle includes four camera members mounted to the exterior of a vehicle and in communication with a wireless display screen disposed on the dash of the vehicle. The camera members are mountable to the exterior of the vehicle through an attachment surface which includes a permanent adhesive and respectively positioned so as to provide a front right, front left, rear right, and rear left views. The display screen may define a discrete touchscreen mountable to the dash of the vehicle or it may be integral with an existing display screen on the vehicle. In operation, the vehicle mounted side camera system is operative to selectively display video from either the two front camera members or two back camera members simultaneously as a split screen.

### BACKGROUND OF THE INVENTION

Field of the Invention

This invention relates generally to vehicle surveillance systems and, more particularly, to an auxiliary side camera system for mounting on the exterior of a vehicle.

Description of the Prior Art

The use of conventional backup camera systems on vehicles to display activity behind the vehicle, particular when the vehicle is in reverse, is well known. In many vehicles equipped with backup camera systems, a display screen integral in the vehicle's dashboard is operatively connected to one or more cameras mounted on the exterior of the vehicle such that when desired, the display screen displays real time video as it is captured by the exterior cameras. It is appreciated that through such systems, an operator of the vehicle is provided with a view of the activity in the exterior camera's line of sight without having to turn to face that direction.

A problem which still exists, however, is that backup camera systems fail to address many of the more dangerous blind spots an operator may face while operating a vehicle. Thus, there remains a need for a vehicle mounted side camera system which would provide side views for either the front or rear of a vehicle. It would be helpful if such a vehicle mounted side camera system included audible alerts to provide a supplemental notification if motion is detected. It would be additionally desirable for such a vehicle mounted side camera system to include discrete cameras selectively mountable to the exterior of a vehicle so as to allow viewing angles customized by type of vehicle.

The Applicant's invention described herein provides for a vehicle mounted side camera system adapted to provide a display of activity to the side of the front of rear of a vehicle. The primary components in Applicant's vehicle mounted side camera system are a wireless cameras and a wireless display screen. When in operation, the vehicle mounted side camera system enables a user to visually inspect the area to the side of the front and rear of their vehicle even if direct viewing is obscured by other vehicles, such as when exiting a parking spot with vehicles on either side. As a result, many of the limitations imposed by prior art structures are removed.

### SUMMARY OF THE INVENTION

A vehicle mounted side camera system for providing real time side view video of the area in front or behind a vehicle. The vehicle mounted side camera system includes four camera members mounted to the exterior of a vehicle and in communication with a wireless display screen disposed on the dash of the vehicle. The camera members are mountable to the exterior of the vehicle through an attachment surface which includes a permanent adhesive and respectively positioned so as to provide a front right, front left, rear right, and rear left views. The display screen may define a discrete touchscreen mountable to the dash of the vehicle or it may be integral with an existing display screen on the vehicle. In operation, the vehicle mounted side camera system is operative to selectively display video from either the two front camera members or two back camera members simultaneously as a split screen.

It is an object of this invention to provide for a vehicle mounted side camera system which provides side views for either the front or rear of a vehicle.

It is another object of this invention to provide a vehicle mounted side camera system which includes audible alerts to provide a supplemental notification if motion is detected.

It is yet another object of this invention to provide a vehicle mounted side camera system which includes discrete cameras selectively mountable to the exterior of a vehicle so as to allow viewing angles customized by type of vehicle.

These and other objects will be apparent to one of skill in the art.

### BRIEF DESCRIPTION OF THE DRAWINGS

FIG. 1 is top plan view of the wireless cameras of a vehicle mounted side camera system built in accordance with the present invention in position on a vehicle.

FIG. 2 is an elevational view of a wireless camera of a vehicle mounted side camera system built in accordance with the present invention.

FIG. 3 is an elevational view of the display screen a vehicle mounted side camera system built in accordance with the present invention.

### DETAILED DESCRIPTION OF THE INVENTION

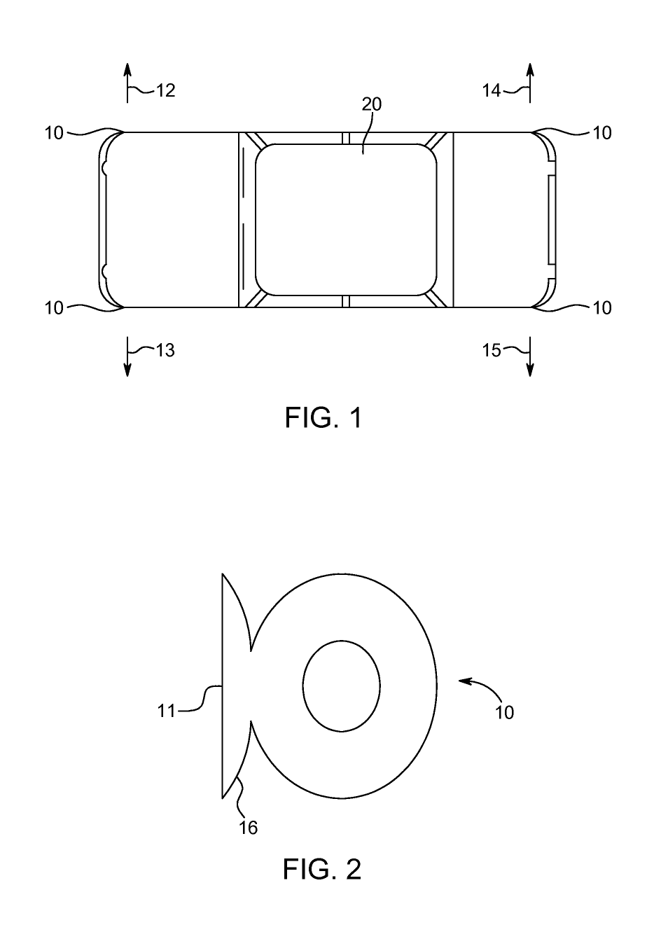

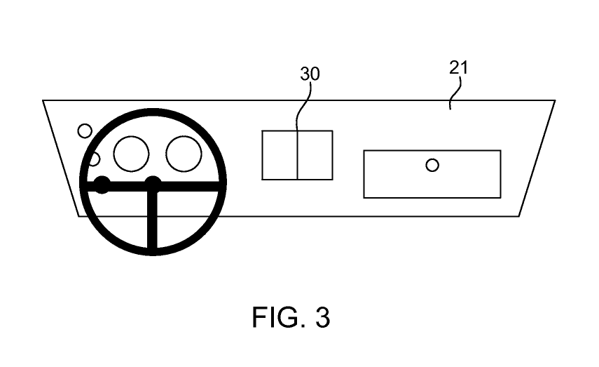

Referring now to the drawings and in particular FIGS. 1, 2, and 3, a vehicle mounted side camera system is shown as a plurality of camera members 10 mounted to the exterior of a vehicle 20 and a wireless display screen 30 disposed on the dash 21 of the vehicle 20. The camera members 10 each define a video camera disposed on a housing which additionally includes an onboard power source, a controller, and a wireless networking interface. In the preferred embodiment, the power source defines a battery and the networking interface defines a Bluetooth antenna. The housing additionally includes an attachment surface 11 which includes a permanent adhesive for attaching the camera member 10 to the exterior of the vehicle 20. In alternate embodiments, the camera members 10 may be attached through a conventional elongated fastener.

The display screen 30 defines an electronic visual display with a touchscreen layered on top and which includes a wireless networking interface and a controller. It is contemplated that in some embodiments, the display screen may be electrically connected to the power source of the vehicle 20 while in other embodiments, it may include an internal battery. The wireless networking interface is defined in the preferred embodiment as a Bluetooth antenna. Accordingly, it is contemplated that the display screen 30 and the camera members 10 may be operatively connected through conventional Bluetooth bonding such that the video from the camera members 10 is viewable on the display screen 30 in real time and manual inputs from the display screen 30 may be transmitted to the camera members 10.

The vehicle mounted side camera system is initially set up on a vehicle by first affixing the camera members 10 onto the target vehicle 20 in the desired positions. It is contemplated that camera members 10 are desirably placed so that a camera member 10 is directed to the right and left of the front of the vehicle 20, respectively defined as the front right 12 and front left 13, and the right and left of the rear of the vehicle 20, respectively defined as the rear right 14 and rear left 15. In one embodiment, the camera members 10 are placed on the front and rear bumpers of the vehicle 20. In alternate embodiments, the camera members 10 may be positioned in, on, or adjacent to the headlights and tail lights of the vehicle 20 or on the quarter panel of the vehicle 20.

Once in place on the vehicle 20, the camera members 10 are activated one at a time through manual actuation of a activation switch 16. Once the activation switch 16 is actuated for the first camera member 10 being activated, the user uses the display screen 30 to being the pairing process between the display screen 30 and that camera member 10. Once the pairing process is complete, the user defines the relative position of the just paired camera member 10 on the vehicle 20 and moves on to the next camera member 10 to be paired. Through this process, each camera member 10 is bonded with the display screen 30 with its relative position, enabling the display screen 30 to selectively display the view from camera member 10 in response to automated or manual selection.

It is contemplated that in some embodiments, sets of camera members 10 may be packaged together already bonded with a display screen 30.

When in operation, the vehicle mounted side camera system is operative to display video from two camera members 10 simultaneously as a split screen on the display screen 30. It the preferred embodiment, a swipe up on the display screen 30 will cause the display screen 30 to display the real time video from the camera member facing front right 12 and front left 13 and a swipe down on the display screen 30 will cause the display screen 30 to display the real time video from the camera member facing rear right 14 and rear left 15. In alternate embodiments, a tap of the display screen 30 may cause the display screen 30 to display the real time video from the camera member facing front right 12 and front left 13 and a swipe down on the display screen 30. In yet another embodiment, putting the vehicle in reverse causes the display screen 30 to display the real time video from the camera member facing rear right 14 and rear left 15

It is contemplated that the display screen 30 may be a discrete device which is mountable to the dash or may be integrated with an existing display on the vehicle.

In an alternate embodiment, a WLAN (or wireless area network of another spatial scope) is employed in the alternative to Bluetooth.

In one embodiment, the display screen 30 is connected to a speaker 31 and a lighting element 32. In such an embodiment, the controller of the display screen includes software that enables motion sensing in the video feed from the camera members 10 and causes an audible alert to be broadcast over the speaker 31 or the lighting element 32 to illuminate, or both, when motion is detected.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A vehicle mounted side camera system, comprising:
a plurality of discrete camera members, each including a video camera and a wireless camera networking interface, wherein said camera members are each configured to capture video and transmit a feed of video captured in real time over the wireless camera networking interface;
said camera members integrated with a vehicle and positioned such that at least one of said camera member is directed to capture video from the right side in front of the vehicle, at least one of said camera member is directed to capture video from the left side in front of the vehicle, at least one of said camera member is directed to capture video from the right side in the rear of the vehicle, and at least one of said camera member is directed to capture video from the left side in the rear of the vehicle; and
a display screen defining electronic visual display with an integrated touchscreen, wherein said display screen includes a wireless display networking interface and is configured to receive the feed of video from each camera member and selectively display the feed of video captured by the cameras.

2. The vehicle mounted side camera system of claim 1, wherein said display screen is integral with the dash of the vehicle.

3. The vehicle mounted side camera system of claim 2, wherein said display screen defines a discrete device attached to the dash of the vehicle.

4. The vehicle mounted side camera system of claim 1, wherein said camera members are bonded with said display screen.

5. The vehicle mounted side camera system of claim 1, wherein said display screen is configured to simultaneously display the video from the left side in front of the vehicle and the right side in front of the vehicle or the left side in the rear of the vehicle and the right side in the rear of the vehicle.

6. The vehicle mounted side camera system of claim 1, additionally comprising a speaker operatively connected with said display screen, wherein said display screen is operative to cause an audible alert to be broadcast over the speaker when motion is sensed in the video from the left side in front of the vehicle, the right side in front of the vehicle, the left side in the rear of the vehicle, or the right side in the rear of the vehicle.

7. The vehicle mounted side camera system of claim 1, additionally comprising a lighting element operatively connected with said display screen, wherein said display screen is operative to cause the lighting element to illuminate when motion is sensed in the video from the left side in front of the vehicle, the right side in front of the vehicle, the left side in the rear of the vehicle, or the right side in the rear of the vehicle.

8. A vehicle mounted side camera system, comprising:
at least four discrete camera members, each including a video camera and a camera Bluetooth interface, wherein said camera members are each configured to capture video and transmit a feed of video captured in real time over the camera Bluetooth interface;
said camera members mounted on a vehicle and positioned such that at least one of said camera member is directed to capture video from the right side in front of the vehicle, at least one of said camera member is directed to capture video from the left side in front of the vehicle, at least one of said camera member is directed to capture video from the right side in the rear of the vehicle, and at least one of said camera member is directed to capture video from the left side in the rear of the vehicle; and
a display screen defining electronic visual display with an integrated touchscreen, wherein said display screen includes a display Bluetooth interface and is bonded with each of the camera members, thereby enabling the display screen to receive the feed of video from each camera member and selectively display the video from the left side in front of the vehicle and the right side in front of the vehicle or the left side in the rear of the vehicle and the right side in the rear of the vehicle.

9. The vehicle mounted side camera system of claim 8, additionally comprising a speaker operatively connected with said display screen, wherein said display screen is operative to cause an audible alert to be broadcast over the speaker when motion is sensed in the video from the left side in front of the vehicle, the right side in front of the vehicle, the left side in the rear of the vehicle, or the right side in the rear of the vehicle.

10. The vehicle mounted side camera system of claim 8, additionally comprising a lighting element operatively connected with said display screen, wherein said display screen is operative to cause the lighting element to illuminate when motion is sensed in the video from the left side in front of the vehicle, the right side in front of the vehicle, the left side in the rear of the vehicle, or the right side in the rear of the vehicle.
